(19) United States
(12) Patent Application Publication
(10) Pub. No.: US 2010/0194251 A1
(43) Pub. Date: Aug. 5, 2010

(54) Axial generator for Windcrank™ vertical axis wind turbine

(76) Inventor: George W. Sikes, Crystal River, FL (US)

Correspondence Address: George W. Sikes, P.O. Box 74, Crystal River, FL, 34423, US

(21) Appl. No.: 12/657,926

(22) Filed: Jan. 29, 2010

Related U.S. Application Data
(60) Provisional application No. 61/206,592, filed on Feb. 2, 2009.

(51) Int. Cl. H02K 21/24; H02K 11/04; H02K 5/10

(52) U.S. Cl. 310/68 D; 310/156.37; 310/88

(57) ABSTRACT

An axial field generator for use with the Sikes Windcrank™ vertical axis wind turbine is disclosed. One embodiment of the axial generator employs: 16 pairs of puck or disk shaped permanent magnets are provided radial and angular location by an index plate. and mounted on two opposing soft steel rotor plates by virtue of magnetic force. the magnets mounted with opposing fields that alternate in pole orientation: and a stator with 12 electronically commutated circular coils loaded with ferrite cores. The stator is a dielectric plate structure interposed between the opposing rotor plates. The stator coils may be switched to provide 4 poles in a three-phase AC configuration, up to 12 phase with single poles for each phase; or electronically rectified and commutated to provide DC voltage, that may be inverted into any useful wave form. This novel configuration of opposing field magnets in the rotor, and stator having fewer coils than magnets), has been found to produce useful electrical power with no cogging effect. low heating loss, and at a low RPM suitable for direct drive off of the Windcrank™ output shaft. The generator is also easy to produce with minimal expense in specialized tooling.

### BACKGROUND

The field of the invention is electrical power generating equipment having permanent magnet rotor elements: and stationary (non-rotating) coils that generate alternating electric current output when the rotor is driven by a prime mover such as a wind turbine. Many generators are designed for high speed operation, and require gearing up when mated to a low speed prime mover such as a wind turbine. Many generator configurations exhibit strong torque variance with angular variation of the rotor to the stator known as “cogging” that is unsuitable for prime movers with a low starting torque. Large permanent magnets in such generating equipment are usually difficult to position and assemble due to high forces of attraction or repulsion with other magnets and magnetic materials used. Many such generators have coils that are exposed and are unsuitable for continuous exposure to a wide range of climatic conditions. Most generators are of the radial field type, and usually require curved magnet elements for efficient operation. and usually require high tooling cost to produce. Many generators are designed for high power density, and consequently have low rotational mass and very little flywheel effect to smooth torque variations.

### OVERVIEW

The axial generator of this invention is specially designed with novel features that particularly match the characteristics of the patented Windcrank™ Vertical Axis Wind Turbine by George Sikes, of Crystal River Fla. (U.S. Pat. No. 6,808,366 Filed: Sep. 11, 2002).

The provisional patent application No. 61/206,592 filed Feb. 2, 2009 by George Winston Sikes of Crystal River Fla. and titled “Axial Generator for Windcrank™ Vertical Axis Wind Turbine” is herby incorporated within by reference.

Some objects and advantages of this invention are:

1) Generator mounted at bottom of Windcrank™ output shaft.

2) Output shaft of Windcrank™ drives magnet rotor directly with no speed-up gear, belt or chain.

3) Outside diameter (OD) of generator less than or equal to the OD of Windcrank™ rotor.

4) Generator thickness along axial dimension of less than half of one Windcrank™ rotor thickness in the axial direction: and less than or equal to coil OD

5) Brushless electric energy transfer.

6) Circular disk magnet with diameter substantially equal to coil inside diameter (ID); substantially equal to coil core diameter, and approximately 1/10th the rotor diameter of the generator.

7) Coil OD up to double coil ID.

8) Axial field/axial gap (minimize magnet machining/forming cost, simplified assembly, and dirt tolerant).

9) 12 coil/16 magnet pairs for simplified 3 phase wiring or electronic commutation switching.

10) Controller to do one of the following: rectify AC current from each coil into DC; rectify AC current from each coil into DC and invert to match or duplicate grid AC; switch AC pulses to amplify grid wave;

11) Produce useful electrical power at the typical operating speed of the Windcrank™.

12) Low starting torque, and cog free to facilitate self starting at low wind speed

13) Controller switches output current to optimize torque and RPM to maximize power output of wind turbine for variable wind conditions.

14) Potted in durable weather proof materials.

15) Open design for ease of inspection, cleaning, and cooling.

16) High rotational mass for smooth operation with fluctuating torque input.

### DRAWINGS

FIG. 1 is an assembled view of the axial generator of this invention mounted on a Windcrank™ vertical axis wind turbine.

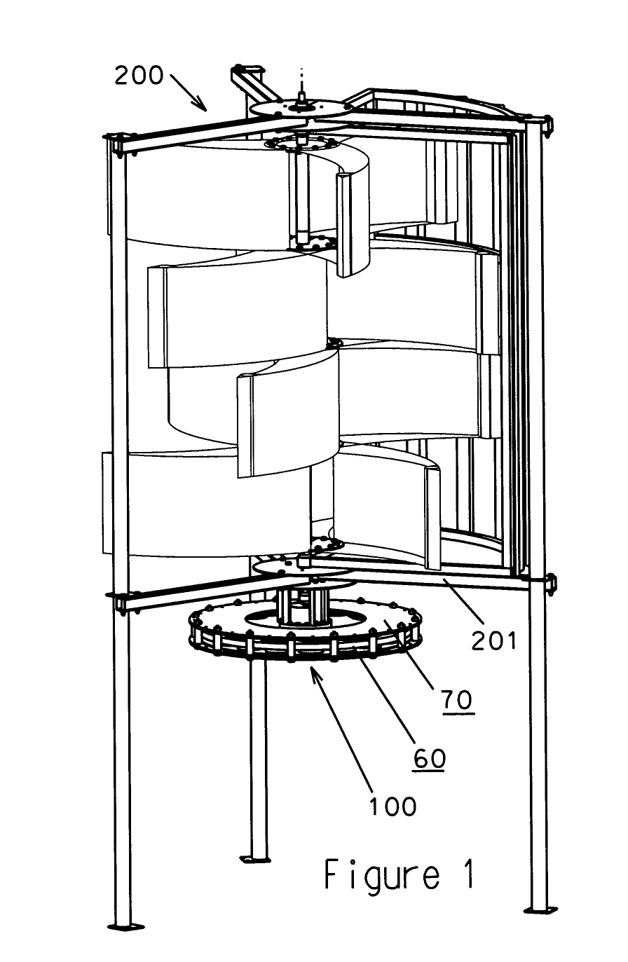

FIG. 2 is an exploded view of the axial generator showing all major components and their relations.

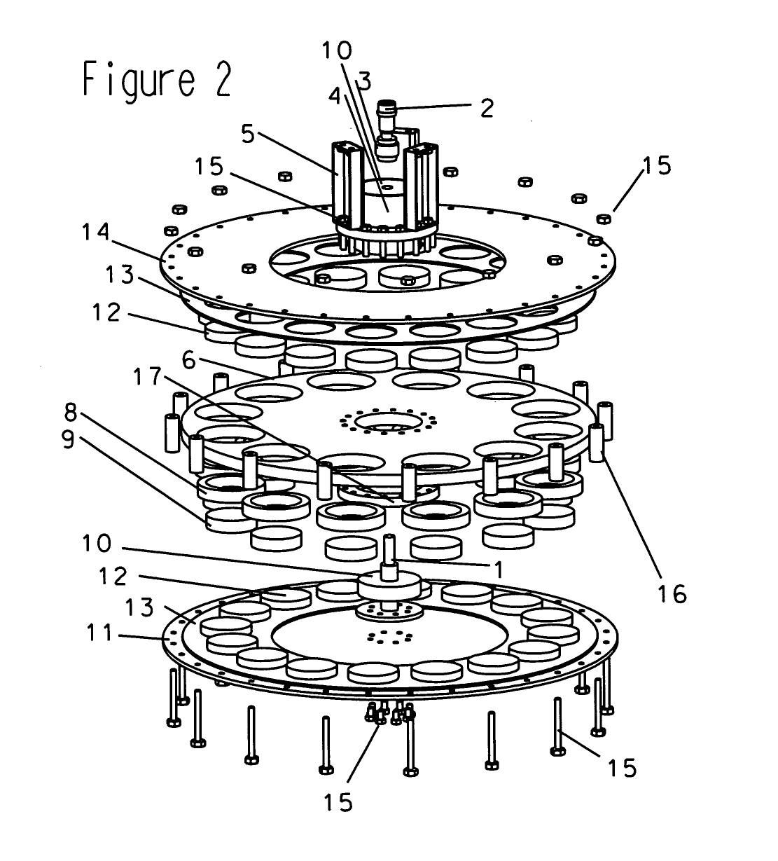

FIG. 3 is a plan view of the rotor magnet index ring with phantom outline of the stator coils to clearly show the radial and angular relationships of the magneto-electric components.

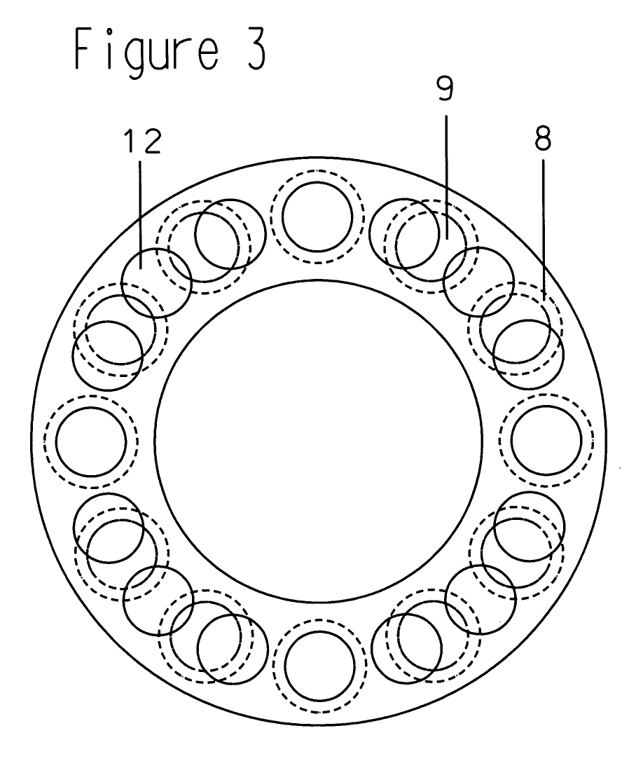

### DETAILED DESCRIPTION

The generator 100 is preferably mounted direct drive on the bottom of the Windcrank™ wind turbine 200. A generator input shaft 1 is mounted to the output shaft 2 of the wind turbine 200 with a coupler (3) that allows some radial and axial misalignment. A bearing housing 4 is mounted to the support frame 201 of the wind turbine with durable members 5 of sufficient stiffness and strength to support the generator in any ambient conditions normally encountered.

A stator plate 6 made of a strong and ridged dielectric material preferably fiber-reinforced. Holes 7 for electrically conductive coils 8 are bored through the plate 6 and wiring chases are routed into the material to accept the leads from the coils 8 with sufficient room to allow for all-weather potting material such as thermo set resin and/or fiber reinforcements.

The stator 60 is mounted to the bearing housing 4 with a retaining ring 17 that is mounted to the wind turbine frame 201. The preferred number of coils 8 in the stator plate 6 is in multiples of three to accommodate three-phase wiring of the coils 8 in either a parallel or series winding pattern. The stator 60 coils 8 are preferably made of copper or aluminum Litz wire, or alternatively with coiled ribbon strips to maintain highest voltage and current from a given magnetic flux.

Depending on the desired electrical load, different coil 8 numbers and arrangements are selected to match the wind turbine 200 to the load for direct drive. For the preferred embodiment twelve coils 8 are selected and three sets of four coils 8 are connected in series or parallel depending on the output desired. The coils 8 have equal angular spacing.

With the use of high efficiency electronic controllers known to those versed in the art, three phase, four phase, six phase or twelve phase coil wiring schemes are all possible within the scope of the invention. The controller can switch, transform, and match phase electronically to match the variable frequency of the wind turbine with fixed frequency and phase needs on the load side.

The coils 8 cores are preferably loaded with a non-conductive ferrite material 9 to contain a magnetic flux while maintaining low eddy current losses, or alternatively with coiled insulated, and magnetically soft steel laminations. The coils 8 and cores 9 are all cast in dielectric potting material encapsulated within the stator plate 6 along with the lead wires that emerge from the stator near the mounting leg 5 for convenient routing to the electric load (and/or load controller).

A shaft 1 is supported in the housing 4 with antifriction hearings 10. The shaft 1 runs all the way through the housing 4 and stator plate 6, and is mounted to a lower rotor plate 11. The housing bearings 10 control the position of the rotor 70 in relation to the stator 60 such that a minimal air gap is maintained between the rotor 70 and stator 60.

The lower rotor plate 11 is preferably made of a material that provides a magnetic flux path for lower rotor magnets 12. The lower rotor magnets 12 are fixed to the lower rotor plate 11 by attractive magnetic force, and precisely located and indexed to the plate 11 with a magnet index ring 13. The magnet indexing ring 13 is mounted to the lower rotor plate 11 with conventional fasteners 15 and or adhesive means. When twelve stator coils 8 are used with ferro-magnetic cores 9. it is found that using sixteen magnet 12 pairs (upper paired to lower) eliminates any cogging effect.

It is preferred that the number of magnet 12 pairs correspond to the multiple of the phase number divided into the number of stator coils 8, thus the use of three phase will work best with numbers of magnet 12 pairs evenly divisible by four.

The lower rotor plate 11 is mounted to a upper rotor plate 14 with threaded fasteners 15 and spacers 16 to set the airgap clearance. This feature allows ample cooling air to the rotor 70, and the cooling effect is highest during high wind that results in the highest power. The upper magnets 12 are mounted to the upper rotor plate 14 using an index ring 13 that is aligned with the lower index ring 13 so the magnets 12 are oriented in repulsion (preferred for less stator 60 stress) or attraction. The preferable pole orientation alternates, so an even number of pairs is used the number is according to the particulars of load and wind for any given installation. The preferred configuration suited for the prototype Windcrank™ wind turbine has sixteen magnet 12 pairs with equal angular and radial spacing.

A ice/snow shield (not shown in drawings) is preferred in climates where icing is likely.

The axial generator 100 is suited to low RPM operation typical of wind turbines 200. It is simple to produce with low cost tooling. There are no brushes, belts or gears to maintain, and long life in harsh conditions is assured.

Operation:

A prototype axial generator designed specifically for a 4′ diameter Windcrank™ wind turbine (nominal rating of 2 kW) has a diameter of about 30 inches, a rotor height almost 3 inches, and a magnet diameter of about 3 inches and V2″ thick. The coil outside diameter is almost 6 inches, having 1100 turns of 0.75 mm epoxy insulated copper wire potted (with epoxy-ferrite cores) in a ½″ thick stator plate made of “Tufnol”. At 70 RPM, the max sustained power was 5 kW at a voltage of 110 with no adverse heating tendency observed in any of the materials. It is appreciated that the generator of this invention will have applications to absorb power from and or be mounted to, other prime movers including but not limited to: water wheels, hydro-power turbines, horizontal shaft prime movers, etc.

I claim:

1) An axial field electrical energy generation device comprising:
a) An input shaft to accept input mechanical rotational power from a prime mover turbine output shaft, and
b) a hub with anti friction bearings to rotationally mount said input shaft to the body of said prime mover, and
c) a rotor assembly mounted to opposite end of said input shaft than the prime mover, said rotor assembly having an even numbered plurality of paired disk shaped magnets aligned with indexing means having equal radial and angular position, attached by their inherent magnetic force, and, to the inside surface of an upper and lower “soft” pair of magnetic material disks, said magnet magnetic force vectors aligned in the axial direction, said magnet pairs oriented so they repel each other in the pair, and having alternating polarity for each adjacent pair in the angular direction of the rotor rotation; and whereas each pair of magnets having a rotational operational clearance between said magnet pair faces, and
d) a stator assembly fixed to said hub such that said stator assembly is situated in-between said upper and lower magnet pairs of said rotor assembly plates, said stator plate having a plurality of electrically conductive coils embedded with equal angular spacing around the circumference of said stator plate, said coils having the same radial mounting distance from the axis as said magnet pair axes of said rotor assembly, whereas said coils are wound with a void center the same diameter as said magnets, said void area in the center of said coils filled with ferrite material such that the coils and cores are flush with the upper and lower surface of said stator plate, and
e) electrically conductive wires embedded in said stator plate to connect said coils such that useful electrical energy may be produced whenever said prime mover rotates with sufficient force and speed.

2) The axial field electrical energy generation device of claim 1 further comprising: an electrical conversion controller to convert the electrical power from said device to a different desired phase, frequency, voltage, or reduced power level.

3) The axial field electrical energy generation device of claim 1 whereas:
a) the number of magnet pairs is 16 and the number of coils is 12 whereas three phase power is produced with 4 times the rotational frequency, or
b) the number of magnet pairs is 24 and the number of coils is 18 whereas three phase power is produced with 5 times the rotational frequency, or
c) the number of magnet pairs is 32 and the number of coils is 24 whereas three phase power is produced with 6 times the rotational frequency.

4) The axial field electrical energy generation device of claim 1 further comprising a weather shield.

5) The axial field electrical energy generation device of claim 1 further comprising any or all of the following:
a) coils made from edge wound ribbon conductors, and/or
b) cores made of magnetically “soft” edge wound ferromagnetic ribbon material; and/or
c) magnets made of NdFe material.
